(19) United States
(12) Patent Application Publication
(10) Pub. No.: US 2025/0152312 A1
(43) Pub. Date: May 15, 2025

(54) ORTHODONTIC APPLIANCE FOR CORRECTING MISALIGNMENT OF TEETH

(71) Applicant: World Class Technology Corporation, McMinnville, OR (US)

(72) Inventors: Alberto Ruiz-Vela, Rancho Cucamonga, CA (US); Juergen Bathen, McMinnville, OR (US)

(21) Appl. No.: 18/942,362

(22) Filed: Nov. 8, 2024

Related U.S. Application Data
(60) Provisional application No. 63/597,662, filed on Nov. 9, 2023.

(51) Int. Cl. A61C 7/22; A61C 7/16

(52) U.S. Cl. CPC A61C 7/22; A61C 7/16

(57) ABSTRACT

An orthodontic device for treating misalignment of teeth, the device including a base and a mount insertable into a seat of the base. The mount includes a receiver designed for receiving an arm therein, wherein the mount is rotatable about a rotational axis relative to the seat to adjust a position of the arm when the arm is coupled to the receiver. In some embodiments, the arm may be cut to length prior to insertion into the receiver to customize the orthodontic device as needed.

### CROSS REFERENCE TO RELATED APPLICATION

This application is a nonprovisional of and claims the benefit under 35 U.S.C. § 119(e) of U.S. Provisional Patent Application No. 63/597,662, filed Nov. 9, 2023, the disclosure of which is incorporated by reference herein in its entirety.

### BACKGROUND

The disclosure relates generally to the field of orthodontic appliances, and in particular, to orthodontic appliances designed for use in correcting misaligned teeth.

In orthodontics, a malocclusion generally refers to a misalignment of teeth in the upper and lower dental arches that may result in an abnormal bite for a patient. Various orthodontic devices, such as dental braces and other correction devices, are commonly used to help properly align a patient's teeth and address other flaws generally relating to the teeth and jaw. For treating malocclusions, the corrective orthodontic appliance that is used typically depends on the severity and nature of the misalignment.

Malocclusions are commonly classified into three classes. A Class I malocclusion is generally characterized by a slight overlap of the upper teeth over the lower teeth. In these cases, the patient's bite may be relatively normal, but the teeth may have issues with spacing, crowding, and/or angular orientation (for example, the teeth may be angled rearwardly toward the tongue or forwardly toward the lips). In a Class Il malocclusion (colloquially referred to as an overbite), the upper teeth stick out over the lower teeth and may be angled toward the tongue or lips in a similar fashion as a Class I malocclusion, but a Class II malocclusion is more severe and significantly impacts a patient's bite. Finally, in a Class III malocclusion (colloquially referred to as an underbite), the lower teeth stick out beyond the upper teeth, and may include teeth angled toward the tongue or lips, and/or may also include teeth forming an abnormally shaped arch for the patient.

To address a Class I malocclusion, an orthodontic appliance may be used to gradually expand the upper jaw to create space for the teeth to erupt properly and in a correct alignment. If necessary, braces or other appliances may be used as a secondary measure to subsequently adjust and straighten the teeth. For Class II and Class III malocclusions, an orthodontic appliance may be used to gradually adjust the patient's bite and correct the misalignment. Typically, a primary goal of the treatment protocol for addressing Class II and Class III malocclusions is to adjust the patient's teeth to attain a Class I condition. Thereafter, the same process as described above for correcting the Class I malocclusion may be applied.

To correct Class II and Class III malocclusions, a wide variety of orthodontic devices have been developed to exert biasing forces on the mandible, either anteriorly or posteriorly as needed. For example, one conventional orthodontic device includes a configuration utilizing a rigid, elongated arm that attaches along one end to a first tooth (typically a molar) and attaches along another end to a second tooth (typically a cuspid or bicuspid) on the same dental arch (such as the maxillary arch). This type of device also incorporates an elastic element (such as a rubber band) that attaches to a mesial end of the elongated arm and attaches to an anchor on a third tooth (such as a first or second molar) of the other dental arch (such as the mandibular arch). Once in position, the device is designed to apply appropriate forces to correct the malocclusion over time.

The present inventors have identified several disadvantages associated with conventional corrective devices for treating malocclusions. For example, the devices present installation challenges, the devices require significant in-office labor for customization to treat individual patient needs, the devices lack a streamlined design with minimal and easy-to-install components, and the devices are not universal and easily adaptable for a wide variety of patients. Accordingly, the present inventors have identified a need for an improved orthodontic correction device having a flexible, universal design for accommodating a wide variety of patients and a streamlined component design to simplify installation. Additional aspects and advantages will be apparent from the following detailed description of example embodiments, which proceeds with reference to the accompanying drawings.

### BRIEF DESCRIPTION OF THE DRAWINGS

FIG. 1 illustrates a conventional orthodontic device in accordance with one embodiment.

FIG. 2 illustrates the conventional orthodontic device of FIG. 1 in an example arrangement for correcting malocclusions in accordance with one embodiment.

FIG. 3 illustrates another conventional orthodontic device in accordance with an example embodiment.

FIG. 4 illustrates an orthodontic device for correcting malocclusions in accordance with one embodiment.

FIG. 5 is a partially exploded view of the orthodontic device of FIG. 4 illustrating an arm separate from a receiver in accordance with one embodiment.

FIG. 6 is another partially exploded view of the orthodontic device of FIG. 4 (with the arm removed) illustrating a mount separate from a base of the orthodontic device in accordance with one embodiment.

FIG. 7 illustrates the mount and base of the orthodontic device of FIG. 6 in a coupled configuration in accordance with one embodiment.

FIG. 8 is a side view of the orthodontic device of FIG. 4 illustrating an elastic member for securing the mount and arm in position during installation of the orthodontic device in accordance with one embodiment.

FIG. 9 is an enlarged side view of the orthodontic device of FIG. 4 illustrating a stop feature on the base for controlling molar rotation in accordance with an example embodiment.

FIG. 10 illustrates an example rotational range of the arm in the gingival direction relative to the base for controlling molar tipping in accordance with one embodiment.

FIG. 11 illustrates the arm in a neutral position relative to the base in accordance with one embodiment.

FIG. 12 illustrates an example rotational range of the arm in the occlusal direction relative to the base for controlling molar tipping in accordance with one embodiment.

### DETAILED DESCRIPTION OF EXAMPLE EMBODIMENTS

With reference to the drawings, this section describes various embodiments relating to an orthodontic device designed for treating malocclusions and its detailed construction and operation. Throughout the specification, reference to “one embodiment,” “an embodiment,” or “some embodiments” means that a described feature, structure, or characteristic may be included in at least one embodiment of the orthodontic device. Thus, appearances of the phrases “in one embodiment,” “in an embodiment,” or “in some embodiments” in various places throughout this specification are not necessarily all referring to the same embodiment. Further, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like.

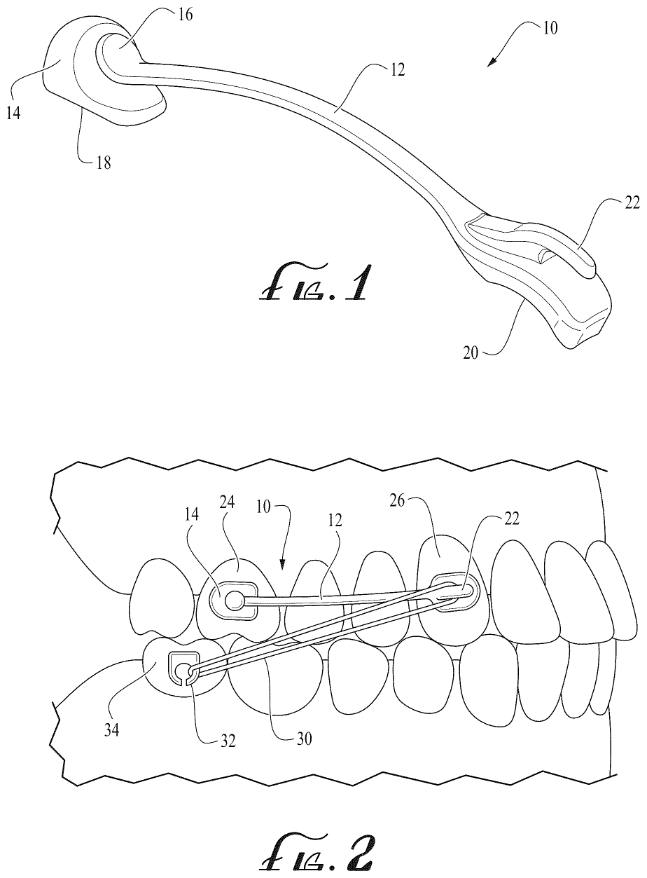

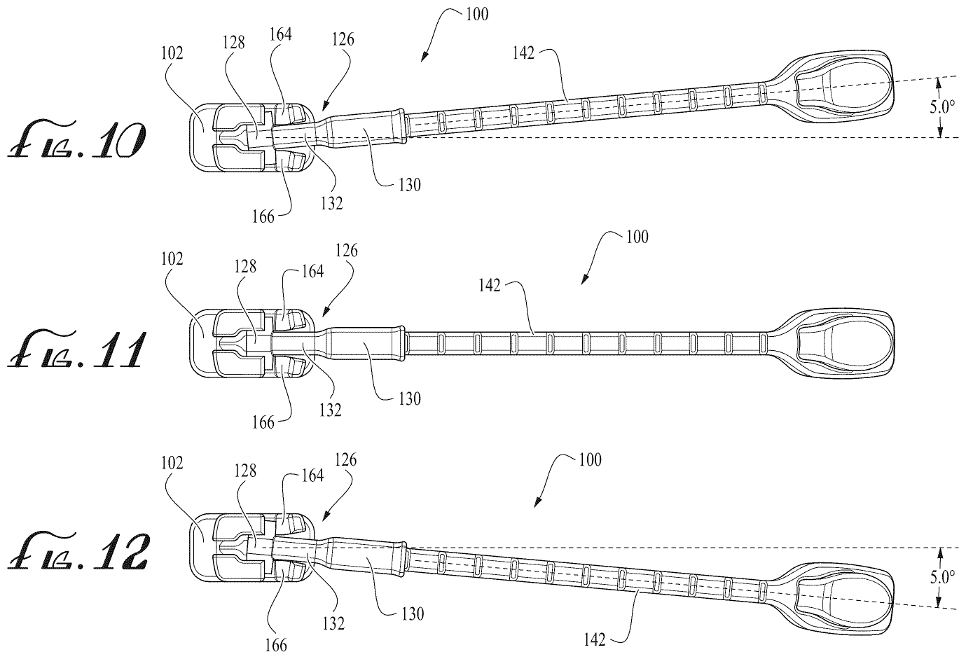

The description below begins with a brief overview of two conventional orthodontic devices used for treating malocclusions with collective reference to FIGS. 1-3, followed by a detailed description of an improved orthodontic device with collective reference to FIGS. 4-12. In the following description, particularly the passages relating to embodiments illustrated in FIGS. 4-12, certain components of the orthodontic device may be described in detail, while others may not be. It should be understood that in some instances, well-known structures, materials, or operations are not shown or described in detail to avoid obscuring more pertinent aspects of the illustrated embodiments. In addition, although the embodiments may illustrate and reference a specific design for an orthodontic device, other embodiments may include additional or fewer components than the described embodiments without departing from the principles of the disclosed subject matter.

FIG. 1 illustrates a conventional orthodontic device 10 in accordance with one embodiment. FIG. 2 illustrates the orthodontic device 10 of FIG. 1 in an example arrangement for treatment of misaligned teeth in accordance with one embodiment. With collective reference to FIGS. 1 and 2, the orthodontic device 10 includes an arm 12 affixed to an anchor 14 via a ball-and-socket joint 16, where the arm 12 is capable of pivoting relative to the anchor 14. In some embodiments, the orthodontic device 10 may be provided in several sizes with an arm 12 of varying lengths to best accommodate treatment opportunities across a wide spectrum of patients. The anchor 14 includes a mounting surface 18 for bonding the anchor 14 of the orthodontic device 10 to a patient's molar (or another suitable tooth). Likewise, the arm 12 includes a mounting surface 20 for bonding the arm 12 to a patient's cuspid (or other suitable tooth) as further described with reference to FIG. 2. In conventional designs, the orthodontic device 10 includes a first configuration for attachment along the left side of the patient's mouth and a second configuration for attachment along the right side of the patient's mouth. The arm 12 further includes a hook 22 for attaching an elastic member 30, such as a rubber band or other suitable component, to effect treatment as further described below.

With collective reference to FIGS. 1-2, in an example configuration for treating a malocclusion, the orthodontic device 10 is coupled to several teeth of the patient's maxilla and mandible in the general fashion as illustrated. For example, in one embodiment, the mounting surface 18 of the anchor 14 is bonded to a maxillary molar 24, and the mounting surface 20 of the arm 12 is bonded to a maxillary cuspid 26. Both the anchor 14 and the arm 12 of the orthodontic device 10 are typically simultaneously mounted to the respective teeth 24, 26 to ensure that the orthodontic device 10 is properly positioned for treatment. Thereafter, the elastic member 30 is attached to the arm 12 via the hook 22 and coupled to a molar anchor 32 bonded to the second mandibular molar 34.

As noted previously, the inventors have identified several potential disadvantages relating to the orthodontic device 10. For example, the ball-and-socket joint 16 connecting the arm 12 and the anchor 14 is a complex solution that provides a limited pivoting action of the rigid arm 12 in all directions. In addition, the ball-and-socket joint 16 requires precision components and specialized assembly during manufacturing—two variables that typically result in an increased product cost. Further, the orthodontic device 10 is designed for bonding as a complete unit such that the anchor 14 and the arm 12 are bonded to the patient's teeth simultaneously. This bonding requirement may minimize positional flexibility for the orthodontic device 10 during installation. In addition, the orthodontic device 10 includes an arm 12 rigidly affixed to the anchor 14 via the ball-and-socket joint 16, where the arm 12 is not intended for detachment from the anchor 14 during ordinary treatment. Accordingly, if one component (e.g., the arm 12 or the anchor 14) of the orthodontic device 10 were to inadvertently detach from a patient's tooth, the orthodontic device 10 would remain dangling freely in the patient's mouth via the other component. This situation would necessitate an emergency visit to a practitioner's office to re-bond the loose component to avoid discomfort and/or potential injury.

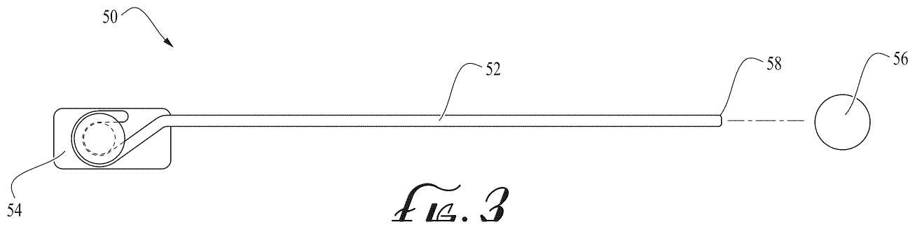

FIG. 3 illustrates another conventional orthodontic device 50 in accordance with one embodiment. With reference to FIG. 3, the orthodontic device 50 includes an arm 52 coupled to an anchor 54 along one end of the arm 52. The orthodontic device 50 further includes a second anchor 56 designed to receive a second end 58 of the arm 52. The arm 52 is typically provided in a long length designed to be cut to size prior to installation by a practitioner to suit a particular patient's need as further described below.

In one example installation procedure of the orthodontic device 50, the arm 52 is initially cut to a desired length by the practitioner. After the arm 52 is cut to a desired length, the second end 58 of the arm 52 is inserted by the practitioner into a small opening or hole (not shown) in the second anchor 56 to set the arm 52 in position. Thereafter, the orthodontic device 50 is bonded to a patient's maxilla via the anchors 54, 56 (along with an elastic member—not shown) in a generally similar process as described with reference to FIG. 2. As with the orthodontic device 10 of FIG. 1, the orthodontic device 50 of FIG. 3 is designed for bonding to the patient's teeth as a unit, where the anchors 54, 56 are simultaneously bonded to a patient's molar and cuspid along the maxillary arch.

While the design of the orthodontic device 50 may provide some flexibility by incorporating an arm 52 that can be cut to a desired length for individualized treatment, one primary disadvantage of this design is that it requires significant in-office labor to ensure the arm 52 remains firmly secured within the second anchor 56 during installation. In addition, if the arm 52 detaches from the second anchor 56, this situation would require an emergency visit to a practitioner's office for handling since the arm 52 would otherwise be left hanging in the patient's mouth via the anchor 52. In some procedures, the second anchor 56 would be de-bonded, the arm 52 would be inserted into the anchor 56, then the anchor 56 and arm 52 would be re-bonded to the tooth. Moreover, the orthodontic device 50 is also designed for simultaneous bonding of the anchors 54, 56, thereby increasing its difficulty of installation in a similar fashion as described with reference to the orthodontic device 10 of FIGS. 1-2.

With collective reference to FIGS. 4-12, the following description relates to an orthodontic device 100 designed to provide various improvements over conventional designs as noted above, including: facilitating installation of the device for treatment, simplifying repair and replacement of individual components in the event of inadvertent dislodgement from a patient's teeth, and streamlining product manufacture with a simple and universal component design for accommodating a wide variety of patients, among other advantages.

Briefly, FIG. 4 illustrates components of the orthodontic device 100 for correcting malocclusions in accordance with one embodiment. As illustrated, the orthodontic device 100 includes an attachment base 102 having a seat 116 (see also FIG. 6) designed to receive a mount 126. In one embodiment, the mount 126 may be slidably inserted into the seat 116 via either an occlusal or gingival direction through openings 118, 122 (see FIG. 6). The mount 126 includes a receiver 130 for receiving an arm 142. The arm 142 is designed to be cut to a desired length prior to insertion into the receiver 130 to allow the orthodontic device 100 to suit the needs of a particular patient. Once the orthodontic device 100 is assembled as illustrated in FIG. 4, the arm 142 may be rotated in a labial-lingual direction via the mount 126 to position the arm 142 in a desired orientation and facilitate installation for clinical treatment as further described below. A detailed description of these and other components of the orthodontic device 100 is provided below with collective reference to FIGS. 4-12.

With reference to FIG. 4, the orthodontic device 100 includes an attachment base 102 having a top surface 104 and an opposite bottom surface 106. The bottom surface 106 of the base 102 may include grooves, channels, or other surface features designed to receive an adhesive or other suitable bonding agent to facilitate mounting or attachment of the base 102 to a selected patient's tooth (e.g., a molar or other suitable tooth) to anchor the orthodontic device 100 for treatment. To establish a frame of reference, the following description (unless otherwise indicated) refers to the base 102 as being attached onto a labial side of a patient's tooth. It should be understood that the illustrated configuration may differ in other embodiments without departing from the principles of the disclosed subject matter.

With reference to FIG. 4, the base 102 includes a lingual side 108 (which includes the bottom surface 106), a labial side 110, an occlusal side 112, and a gingival side 114. It should be understood that terms such as labial, lingual, occlusal, and gingival used to describe the base 102 in this specification are relative to this frame of reference. However, the embodiments of the disclosed subject matter are not limited to the chosen reference frame and descriptive terms, as the orthodontic device 100 may be used in other orientations within the oral cavity. Those having ordinary skill in the art will recognize that the descriptive terms used herein may not directly apply when there is a change in the frame of reference. The disclosed subject matter is intended to be independent of location and orientation within the oral cavity and the relative terms used to describe the illustrated embodiments are to provide a clear description in conjunction with the drawings. As such, the relative terms labial, lingual, occlusal, and gingival in no way limit the disclosed subject matter to a particular location or orientation but are instead offered to aid in understanding the disclosed subject matter.

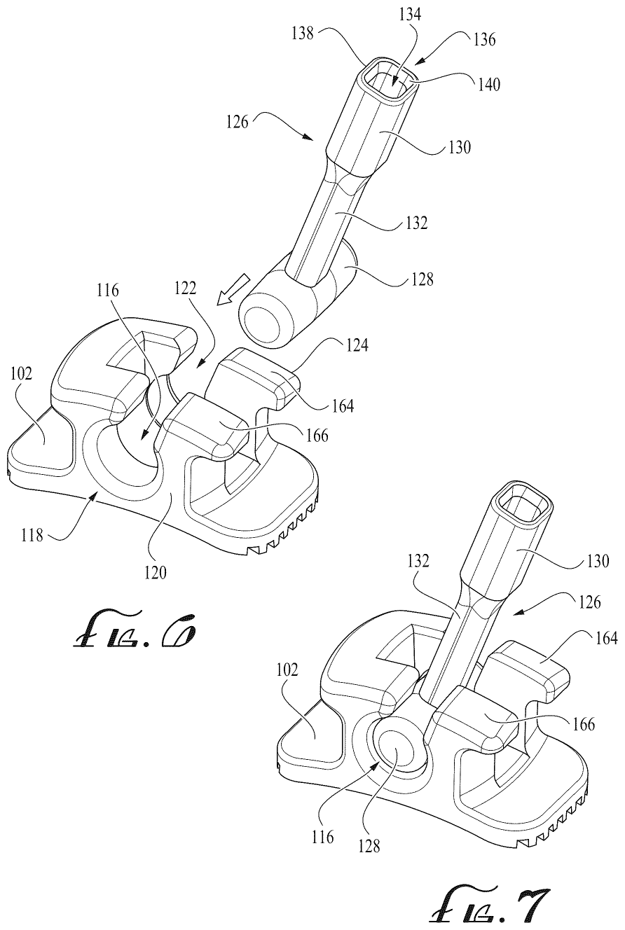

As illustrated in FIG. 4, the base 102 includes a seat 116 (see also FIG. 6) formed along the top surface 104 of the base 102, the seat 116 extending across the base 102 from a first side (e.g., occlusal side 112) to a second side (e.g., gingival side 114). In one embodiment, the seat 116 includes an exterior surface with a generally rounded or curved profile corresponding with an exterior profile of the mount 126. These corresponding profiles are designed to facilitate rotation of the mount 126 relative to the seat 116 as further described in detail below with particular reference to FIGS. 6-7. The seat 116 may include a first opening 118 formed along a first side wall 120 of the base 102 (see FIG. 6), and may also include a second opening 122 formed along a second side wall 124 of the base 102, where the openings 118, 122 are each in communication with, and provide a passageway to, the seat 116. In one embodiment, the openings 118, 122 are axially aligned relative to one another. During an example assembly process of the orthodontic device 100, the openings 118, 122 facilitate a sliding insertion (and a sliding removal as needed) of the mount 126 into the seat 116 through either the occlusal direction (via opening 118) or the gingival direction (via opening 122) to provide flexibility to a practitioner during the installation process.

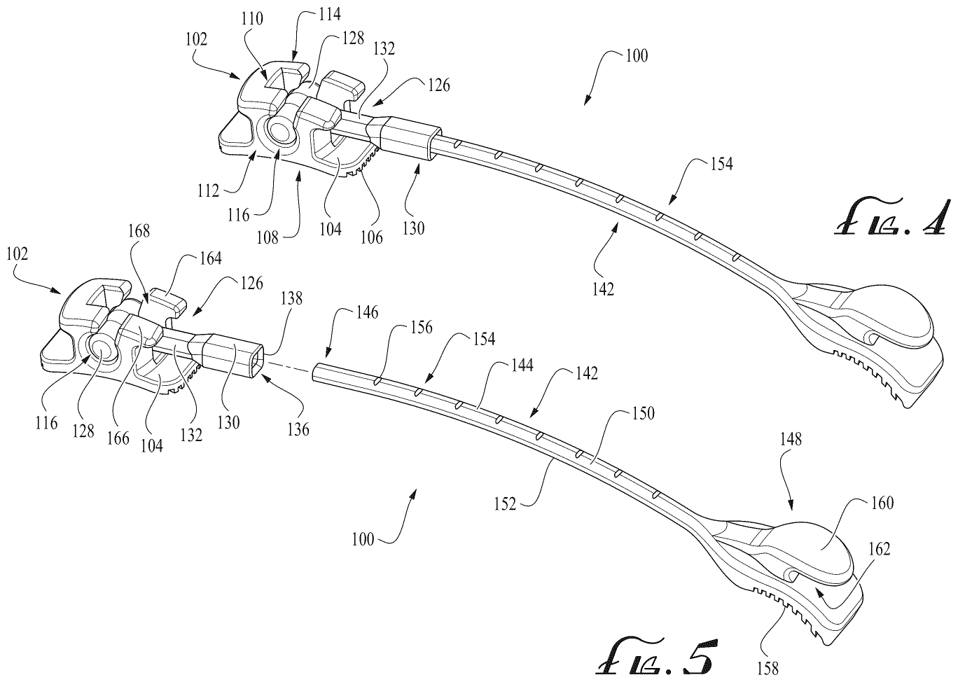

With collective reference to FIGS. 5 and 6, the mount 126 of the orthodontic device 100 is configured for coupling to the seat 116 of the base 102 as described previously. With particular reference to FIG. 6, the mount 126 includes a body portion 128 having an exterior profile corresponding to that of the seat 116. For example, in one embodiment, the body portion 128 includes a generally rounded, tubular profile sized and dimensioned to slidably insert into the seat 116 via the openings 118, 122 as described previously. Once the mount 126 is inserted into the seat 116, the rounded body portion 128 abuts against the seat 116, where the corresponding rounded profiles of the seat 116 and the body portion 128 facilitate rotation of the mount 126 within the seat 116 (see FIG. 7).

Returning to FIGS. 5 and 6, the mount 126 further includes a receiver 130 and a stem 132 extending between the body portion 128 and the receiver 130. In one embodiment, the body portion 128, the receiver 130, and the stem 132 are formed as a single, integral component. The receiver 130 includes a cavity 134 (see FIG. 6) formed therein and extending toward the stem 132, the cavity 134 having an opening 136 along a distal end face 138 of the receiver 130. As further described below, the cavity 134 is dimensioned and sized to receive a portion of the arm 142 of the orthodontic device 100. Accordingly, the depth of the cavity 134 relative to the end face 138 may vary in different embodiments depending on a selected size of the portion of the arm 142 being inserted. Preferably, a suitably-sized portion of the arm 142 is inserted into the cavity 134 to ensure the receiver 130 securely retains the arm 142 in position. For example, in some embodiments, the cavity 134 may have a depth ranging from between 2 mm to 4 mm as measured from the distal end face 138 toward the stem 132. In other embodiments, the depth of the cavity 134 may range between 2 mm to 3 mm. It should be understood that the cavity 134 may have other suitable depths in other embodiments.

With particular reference to FIG. 6, in one embodiment, the receiver 130 includes a ramped section or lead-in portion 140 designed to provide a wider mouth as compared to a width of the cavity 134 to help facilitate insertion and guide the arm 142 into the receiver 130. For example, in one embodiment, the interior walls of the receiver 130 are widest at the end face 138 and gradually narrow or taper inwardly at the ramped section 140 until reaching a portion of the cavity 134 where the walls are spaced at a constant distance relative to one another. In some embodiments, the ramped section 140 encompasses only a beginning portion of the receiver 130, whereas the majority of the cavity 134 may be uniform and dimensioned to be substantially equal to the width of the arm 142 to ensure a secure fit when the arm 142 is inserted. In other embodiments, the receiver 130 may not incorporate any tapering and the cavity 134 may instead have a uniform size throughout.

With particular reference to FIG. 5, the orthodontic device 100 further includes an attachment arm 142 designed for insertion into the receiver 130 as described previously. The arm 142 includes an elongate body 144 having an insertion or coupling portion 146 along one end of the body 144 and a bonding portion 148 along an opposite end of the body 144. The arm 142 may have any suitable length as needed to accommodate treatment for a wide variety of patients. For general reference purposes, the coupling portion 146 is configured to couple the arm 142 with the receiver 130 and the bonding portion 148 is configured to bond the arm 142 to a patient's tooth as further described in detail below. As illustrated in FIG. 5, the elongate body 144 includes a curved profile between the coupling portion 146 and the bonding portion 148. This curvature is designed to generally track a typical curvature of a patient's dental arch and is designed to help ensure the arm 142 clears the patient's teeth when the orthodontic device 100 is installed for treatment.

As illustrated in FIG. 5, the elongate body 144 includes a top surface 150 and an opposite bottom surface 152. In one embodiment, the elongate body 144 includes a scale 154 comprising indicia spaced apart along the top surface 150 of the elongate body 144. The indicia may include a plurality of notches or markings 156 formed on the top surface 150 of the arm 142. The markings 156 may be made using any suitable method to create a visible marking, such as laser marking, etching, ink marking, molding methods to create a recessed portion, or other suitable techniques. The markings 156 may be spaced apart at any suitable intervals on the top surface 150. For example, in one embodiment, the markings 156 may be separated at 1 mm or 2 mm intervals. As further described in detail below, the arm 142 may be cut to a desired length prior to insertion into the receiver 130. Accordingly, the scale 154 (and the markings 156) may be used for measurement purposes and to provide visual cues to the practitioner to ensure that the cut length of the arm 142 is accurate and suitable as needed for a particular patient. In some embodiments, the arm 142 may have an initial length of approximately 35 mm to accommodate use with a wide variety of patients. In some embodiments, the scale 154 may provide longer or larger markings for 2 mm intervals and shorter or smaller markings for 1 mm intervals to provide additional visual cues for measuring and cutting the arm 142 from an initial length to a desired length suitable for the particular patient.

With reference to FIG. 5, the bonding portion 148 of the arm 142 includes a bonding surface 158 formed on the underside of the arm 142 along its bottom surface 152. In some embodiments, the bonding surface 158 may include grooves, channels, or other surface features designed to receive an adhesive or other suitable bonding agent to attach the bonding portion 148 of the arm 142 to a patient's tooth. The arm 142 further includes a hook 160 formed along the top surface 150 of the arm 142, the hook 160 including a gap or a seat 162 designed for receiving and securing a rubber band or other suitable elastic member during treatment in a similar fashion as described previously with reference to the orthodontic device 10 of FIGS. 1-2.

With collective reference to FIGS. 4-8, the following describes an example coupling and installation process for the orthodontic device 100 in accordance with one embodiment. It should be understood that while the installation process described below provides a suggested order of steps for the installation, the steps may be completed in a different order or may be combined in other embodiments without departing from the principles of the disclosed subject matter.

With initial reference to FIGS. 6 and 7, one example installation process begins with the practitioner slidably inserting the mount 126 into the seat 116 of the base 102. As noted previously, the mount 126 may be inserted from the occlusal direction via the opening 118 or from the gingival direction via the opening 122. Once the mount 126 has been fully inserted into the seat 116 (as shown in FIG. 7), the mount 126 is rotated forwardly toward the base 102 into a position as shown in FIG. 5. With reference to FIG. 5, the base 102 includes a pair of tie wings 164, 166 extending upwardly from the top surface 104 of the base 102. The tie wings 164, 166 are laterally offset from one another along the top surface 104 of the base 102, with a gap or spacing 168 therebetween. In this configuration, the mount 126 may be rotated forwardly to position the stem 132 between the tie wings 164, 166 as illustrated.

With the mount 126 in position, the coupling portion 146 of the arm 142 is ready for insertion into the receiver 130. As noted previously, the elongate body 144 of the arm 142 may be cut to a desired length prior to insertion into the receiver 130 as needed for a particular patient. The scale 154 on the arm 142 may be used to facilitate the measurement and cutting process and ensure the arm 142 is accurately cut to a desired length. Once the arm 142 is cut, the arm 142 is inserted through the distal end face 138 and fully advanced into the cavity 134 of the receiver 130. With the arm 142 in position within the cavity 134, the receiver 130 may be pressed or crimped to secure the arm 142 in position therein and help resist dislodgement. Once the orthodontic device 100 is assembled (as illustrated in FIG. 4), the mount 126 may be rotated within the seat 116 about a rotational axis relative to the base 102 to adjust a position of the arm 142 as desired.

Once the orthodontic device 100 is assembled, it is ready for installation on the patient's teeth. In one example installation, the attachment base 102 may be bonded on a molar (or other suitable posterior tooth) along the maxillary arch of the patient in a similar fashion as generally described with reference to FIG. 2. As noted previously, the base 102 may be bonded onto the patient's tooth using an adhesive or bonding agent on the bottom surface 106 of the attachment base 102. Once the base 102 is bonded in a suitable position on the patient's tooth, the mount 126 is rotated to position the arm 142 in a substantially horizontal position for installation (similar to the arrangement shown in FIG. 4). With the arm 142 in position, the bonding portion 148 of the arm 142 may be bonded via the bonding surface 156 to another tooth, such as a cuspid (or other suitable anterior tooth), along the maxillary arch (in a similar overall position as shown in FIG. 2). Thereafter, a second anchor (not shown, but may be any suitable anchor design with a hook for receiving an elastic member) is bonded to another tooth of the patient (such as a second molar) along the mandible. Finally, an elastic member is coupled to the hook 160 of the arm 142 and also coupled to the second anchor on the mandibular arch in an overall similar arrangement as illustrated in FIG. 2 to complete the installation.

With reference to FIG. 8, in one embodiment, the elastic member 170 may be used during the installation process to help secure the mount 126 and the arm 142 in position for bonding. For example, the elastic member 170 may be wrapped around the tie wings 164, 166 to secure the receiver 130 and arm 142 in position against the base 102 and resist rotation of the arm 142 along the labial-lingual direction. Once the base 102 and the arm 142 have been bonded to their respective teeth, the elastic member 170 may be removed from the tie wings 164, 166. In another embodiment, an elastic member (e.g., a member similar to elastic member 170) may instead be separately wrapped around each tie wing 164, 166 to secure the receiver 130 and arm 142 in position while accommodating some movement of the arm 142 in the labial-lingual direction to facilitate bonding of the orthodontic device 100 as a unit. In yet another embodiment, a molded component (e.g., a plastic or other suitable component) instead of the elastic member(s) 170 may be fitted to the wings 164, 166 to secure the receiver 130 and arm 142 in position as desired. In still other embodiments, other suitable components or features may be used to temporarily contain the receiver 130 and arm 142 in position to facilitate bonding.

It should be noted that while the installation process of the orthodontic device 100 described above provides an example where the base 102 and the arm 142 are individually or successively bonded, the orthodontic device 100 may also be bonded as a unit if desired by the practitioner. For example, the orthodontic device 100 may be assembled in the same fashion as described above. With the orthodontic device 100 assembled, both the base 102 and the arm 142 may be positioned at their respective teeth and simultaneously bonded to install both portions of the orthodontic device 100 at once.

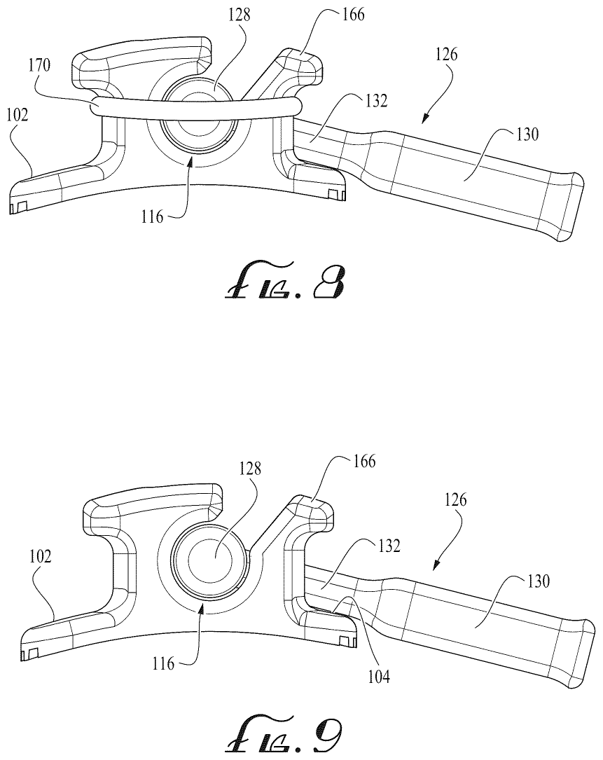

As illustrated in FIG. 9, in some embodiments, the top surface 104 of the base 102 may serve as a stop element or feature designed to restrict vertical movement of the arm 142 along a labial-lingual direction to precisely control molar rotation when the orthodontic device 100 is installed. In addition, as illustrated in FIGS. 10-12, the tie wings 164, 166 collective serve to abut the stem 132 of the mount 126 and restrict lateral movement of the arm 142 in the occlusal-gingival direction within a certain target range (e.g., ±5 degrees) to control molar tipping when the orthodontic device 100 is installed.

As described with general reference to the embodiments of FIGS. 4-12, the streamlined design of the orthodontic device 100 provides an overall simplified installation process onto the patient's teeth for treatment. In addition, the orthodontic device 100 provides the flexibility to either bond as a unit (e.g., bonding the base 102 and arm 142 substantially simultaneously) onto a patient's teeth for treatment or bond each component independently from the other. In some instances, the ability to independently bond these components may improve the accuracy and quality of the component placement, both of which raise the likelihood that the components of the orthodontic device 100 will remain properly engaged during treatment when compared to conventional devices. In other instances, bonding the orthodontic device 100 as a unit may be a simpler solution. The orthodontic device 100 offers the flexibility to do both.

Further, the design of the orthodontic device 100 allows practitioners to reduce inventory cost since the orthodontic device 100 is a universal design that allows for insertion of the mount 126 from either an occlusion or gingival direction and that may be used on the right or left side of the patient's maxillary arch. In addition, the orthodontic device 100 provides a universal arm 142 that may be anywhere from 12 mm to 35 mm in length based on where the arm 142 is cut. Relatedly, the ability to uncouple various components (e.g., removing the mount 126 from the base 102 or removing the arm 142 from the mount 126) in the orthodontic device 100 provides flexibility for servicing and repairing individual components without the need to de-bond the orthodontic device 100. As described above, the design of the orthodontic device 100 meets clinical needs while providing flexibility, optimizing inventory costs, and minimizing installation labor, benefits not offered by conventional devices.

It should be understood that while the figures illustrate an example design for an orthodontic device, other configurations may be possible without departing from the principles of the disclosed subject matter. In addition, although the description above contains much specificity, these details should not be construed as limiting the scope of the disclosed subject matter, but as merely providing illustrations of some embodiments. It should be understood that subject matter disclosed in one portion herein can be combined with the subject matter of one or more of other portions herein as long as such combinations are not mutually exclusive or inoperable.

The terms and descriptions used above are set forth by way of illustration only and are not meant as limitations. It will be obvious to those having skill in the art that changes may be made to the details of the above-described embodiments without departing from the underlying principles of the disclosed subject matter.

1. An orthodontic device for treating misalignment of teeth, the device comprising:
a base having a first surface and an opposite second surface, wherein the base includes a seat formed along the first surface, and wherein the second surface is configured for mounting the base to a first tooth;
an arm including a top surface and an opposite bottom surface, the arm having an elongated body with a coupling portion at a proximal end of the arm and a bonding portion at an opposite distal end of the arm, wherein the bonding portion includes a bonding surface formed along the bottom surface of the arm for mounting the bonding portion to a second tooth offset from the first tooth; and
a mount rotatably coupled to the seat of the base, wherein the mount is rotatable about a rotational axis relative to the seat, the mount including a receiver having a cavity formed therein and an opening along an end face of the receiver, the receiver configured for receiving the coupling portion of the arm, and wherein, when the arm is coupled to the receiver, rotation of the mount relative to the seat adjusts a position of the arm relative to the base.

2. The orthodontic device of claim 1, wherein the base includes a first opening in communication with the seat, and wherein the mount is slidable into the seat via the first opening.

3. The orthodontic device of claim 1, wherein the base includes a first opening and a second opening in communication with the seat, the first opening and second opening axially aligned relative to one another, and wherein the mount is slidable into the seat via either the first opening or the second opening.

4. The orthodontic device of claim 3, wherein the mount is further slidably removable from the seat via either the first opening or the second opening.

5. The orthodontic device of claim 1, wherein the mount includes a rounded body portion abutting the seat to facilitate rotation of the mount relative to the seat.

6. The orthodontic device of claim 1, wherein the mount includes a body portion coupled to the seat, the mount further including a stem disposed between the body portion and the receiver.

7. The orthodontic device of claim 6, wherein the base includes a first tie wing and a second tie wing extending from the top surface thereof, and wherein the stem of the mount is disposed between the first tie wing and the second tie wing, and wherein the first tie wing and the second tie wing abut the stem to restrict lateral movement of the stem along an occlusal-gingival direction.

8. The orthodontic device of claim 6, wherein the top surface of the base includes a stop portion configured to abut the stem of the mount and restrict vertical movement of the stem along a labial-lingual direction.

9. The orthodontic device of claim 1, wherein the receiver includes a ramped section formed along the end face thereof to facilitate insertion of the arm into the cavity of the receiver.

10. The orthodontic device of claim 1, wherein the top surface of the elongate body of the arm includes a scale comprising spaced-apart indicia formed thereon.

11. The orthodontic device of claim 10, wherein the spaced-apart indicia further includes a set of markings formed on the top surface of the arm.

12. The orthodontic device of claim 1, wherein the receiver is crimpable to retain the arm in position therein.

13. The orthodontic device of claim 1, wherein the mount is rotatable within a rotational range of between 40 degrees to 75 degrees relative to the base.

14. The orthodontic device of claim 1, further comprising an elastic band coupled to the base, wherein the elastic band resists rotation of the arm along the labial-lingual direction.

15. A method for assembling an orthodontic device for treating misalignment of teeth, the method comprising:
inserting a mount into a seat of the orthodontic device, wherein the mount is rotatable about a rotational axis within the seat;
cutting an arm to a selected length, the arm including a bonding portion with a bonding surface for mounting the arm to a tooth; and
inserting the arm into a receiver of the mount, the receiver having a cavity formed therein with an opening along an end face of the receiver for receiving the arm.

16. A method for installing an orthodontic device for treating misalignment of teeth, the method comprising:
coupling a base to a first tooth along a first dental arch, the base including a top surface and an opposite bottom surface, wherein the base includes a seat formed along the top surface thereof;
coupling a mount to the seat of the base, wherein the mount is rotatable about a rotational axis relative to the seat, the mount further including a receiver having a cavity formed therein, the receiver further including an opening along an end face of the receiver;
inserting an arm into the receiver of the mount;
rotating the mount within the seat with the arm in the receiver to adjust a position of the arm relative to a second tooth along the first dental arch; and
bonding the arm along a bonding surface thereof to the second tooth.

17. The method of claim 16, further comprising crimping the receiver to secure the arm therewith.

18. The method of claim 16, wherein the arm further includes a scale comprising spaced-apart indicia formed thereon, the method further comprising:
determining a length of the arm based at least in part on a distance between the first tooth and the second tooth;
measuring the length of the arm via the spaced-apart indicia; and
cutting the arm to the length prior to inserting the arm into the receiver of the mount.

19. The method of claim 16, wherein the base further includes a first opening in communication with the seat, wherein the step of coupling the mount to the seat further includes sliding the mount through the first opening and into the seat.

20. The method of claim 16, wherein the base includes a first opening and a second opening axially aligned relative to one another and each in communication with the seat, and wherein the step of coupling the mount to the seat further includes sliding the mount into the seat via either the first opening or the second opening.
